(19) United States
(12) Patent Application Publication
(10) Pub. No.: US 2023/0363357 A1
(43) Pub. Date: Nov. 16, 2023

(54) Hummingbird Nesting Platform

(71) Applicant: James Gick, Fallbrook, CA (US)

(72) Inventor: James Gick, Fallbrook, CA (US)

(21) Appl. No.: 17/745,523

(22) Filed: May 16, 2022

(51) Int. Cl. A01K 31/14

(52) U.S. Cl. CPC A01K 31/14

(57) ABSTRACT

The invention concerns the construction and method of use of a hummingbird nesting platform.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to bird nest building. More particularly, the invention concerns the construction and method of use of a hummingbird nesting platform.

### Discussion of the Prior Art

Various types of nesting birdhouses have been suggested in the past and have been offered for sale commercially. However, little has been done in the design and construction of nesting platforms for use by wild birds in constructing their nests. For example, a hanging hummingbird nesting birdhouse is being offered for sale by Chevy, Inc. of Dania, Fla. This nesting birdhouse is made from natural woven grass fiber, is teardrop in shape and includes a hanging rope made of natural fibers that can be used to attach the birdhouse to a tree or hook on an exterior structure such as a porch. In similar fashion, a hanging hummingbird nesting birdhouse is commercially available from Rion PTF Ltd. having offices in Singapore. This hanging birdhouse is generally gourd shaped, is handwoven with durable and breathable fibers and includes a hanging loop to enable the birdhouse to be attached to an exterior structure such as a branch or hook.

Rather than offering for sale only a nesting birdhouse of the character described in the preceding paragraphs, the Uncle Dunkels Company of Corbin, Ky. is offering for sale a nest building nester for use by hummingbirds in constructing their nests. This nester, which is of a completely different design, construction, and method of use from the platform of the present invention, is constructed from poplar tree bark and rot resistant wood. The Uncle Dunkels nester, which is designed to be hung from an external structure by a hanging hook, includes a refillable nesting material holding structure, a nesting cup formed in the floor of the nester, and spaced apart wooden support posts located proximate the nesting cup that provide support to the hummingbird's nest. Hummingbirds are not cavern dwellers and a branch is their preferred and most natural place to nest and not in a structure that resembles a small dollhouse.

In practice, female hummingbirds build their nests several feet high in an intersection of branches of trees or shrubs. Typically, the nests comprise velvety, compact cups with spongy floors and elastic sides that stretch as the young grow. In building their nests, the hummingbirds weave together twigs, plant fibers, and bits of leaves, and use spider silk as threads to bind the nests together and anchor them to the foundation.

### SUMMARY OF THE INVENTION

By way of brief summary, the present invention concerns a hummingbird nesting platform for use by hummingbirds in constructing a nest. In one form of the invention, the nesting platform comprises a first end portion, a second end portion, an intermediate portion, and a decorative nest building material dispensing assembly connected to the first end portion. In the preferred form of the invention, the hummingbird nesting platform further includes connecting means connected to the second end portion of the platform for connecting the platform to an exterior structure.

With the foregoing in mind, it is a primary object of the invention to provide a hummingbird nesting platform of novel design that that can readily be used by female hummingbirds to construct their nest.

Another object of the invention is to provide a hummingbird nesting platform that is of a decorative appearance that will tend to attract wild hummingbirds to the platform during the nesting season.

Another object of the invention is to provide a hummingbird nesting platform of the aforementioned character that is designed and constructed in a manner that encourages hummingbirds to use the platform to build their nest.

Another object of the invention is to provide a hummingbird nesting platform of the character described that includes a refillable supply cup for holding nesting material that can readily be used by the hummingbird in constructing the nest.

Another object of the invention is to provide a hummingbird nesting platform that is easy to use and requires no special skills or equipment to connect the platform to an exterior structure.

Yet another object of the invention is to provide a nesting platform of the character described that is of a simple construction and is durable in use.

### BRIEF DESCRIPTION OF THE DRAWINGS

FIG. 1 is a top perspective view of a Hummingbird Nesting Platform showing my new design;

FIG. 2 is a bottom perspective view thereof;

FIG. 3 is a further top perspective view thereof;

FIG. 4 is a further bottom perspective view thereof;

FIG. 5 is a front elevational view thereof;

FIG. 6 is a rear elevational view thereof;

FIG. 7 is a left side elevational view thereof;

FIG. 8 is a right side devotional view thereof;

FIG. 9 is a top plan view thereof;

FIG. 10 is a bottom plan view thereof; and

FIG. 11 is a cross sectional view taken along lines 11-11 of FIG. 5.

### DETAILED DESCRIPTION OF THE INVENTION

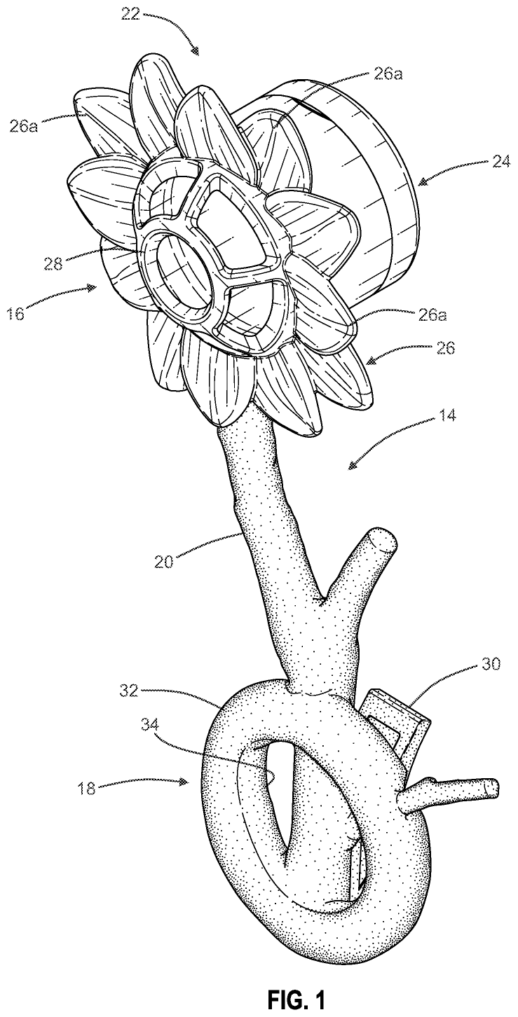

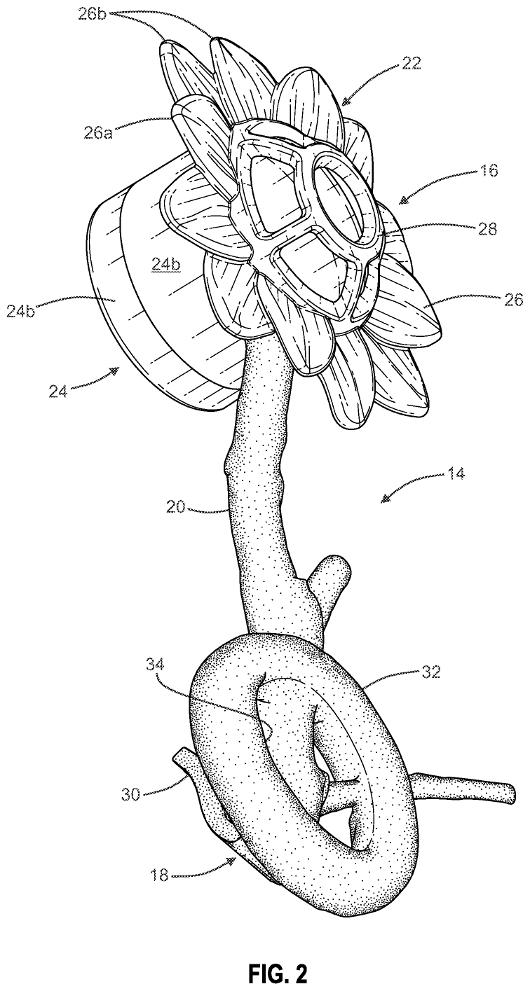

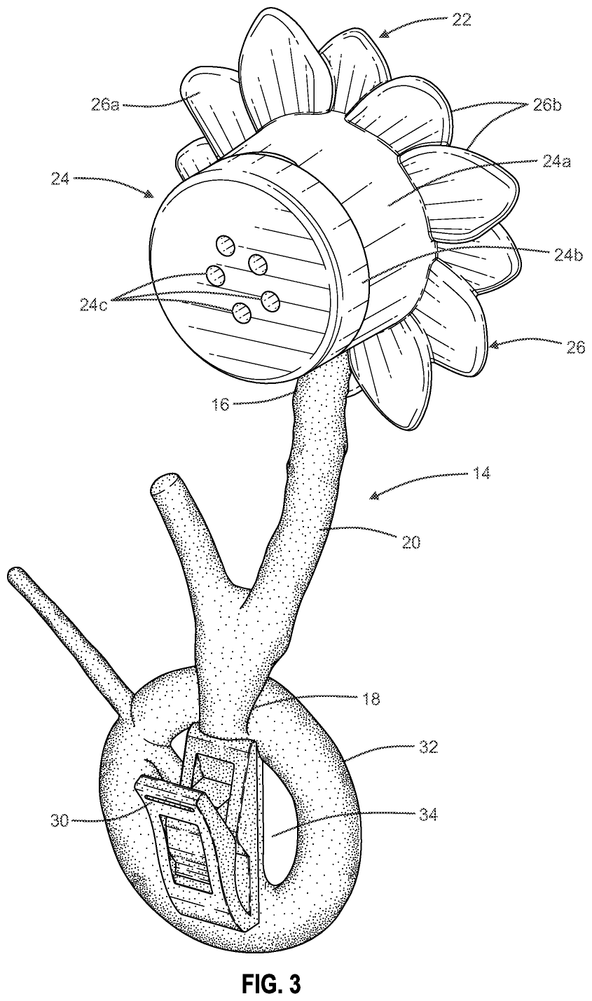

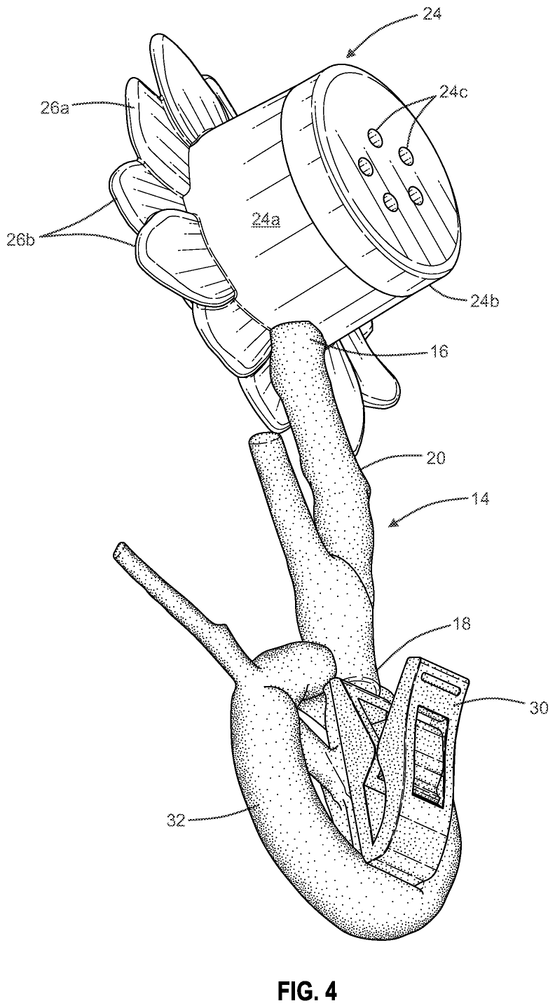

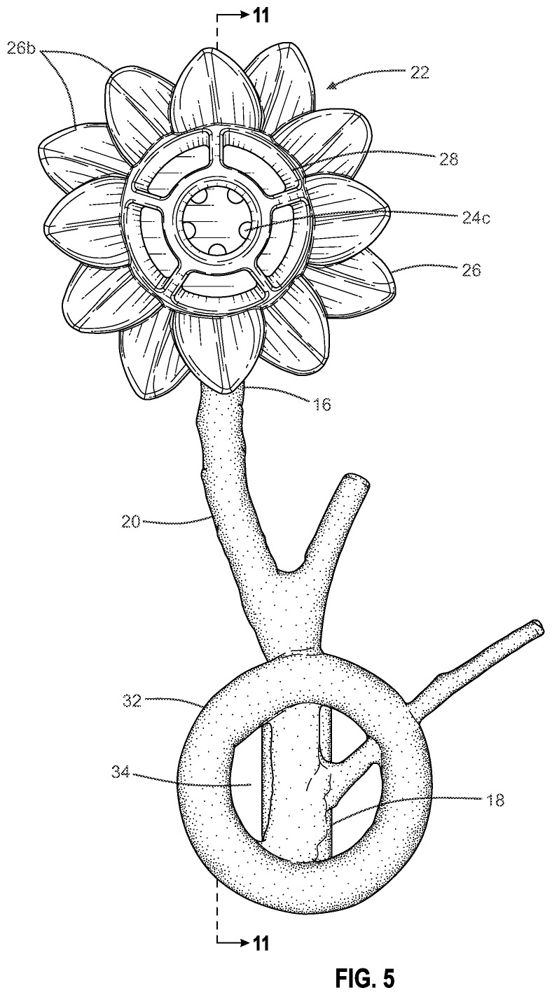

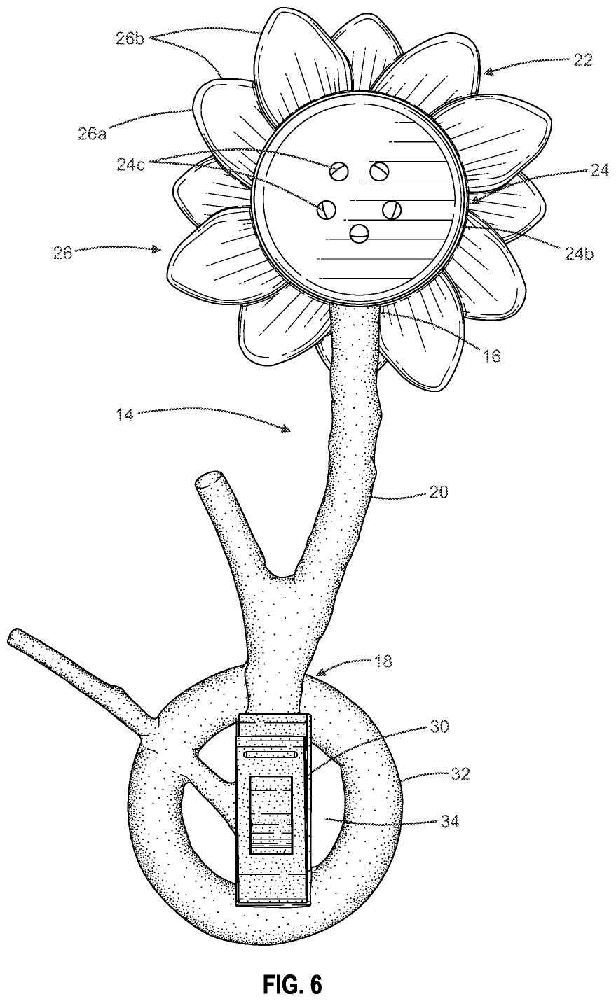

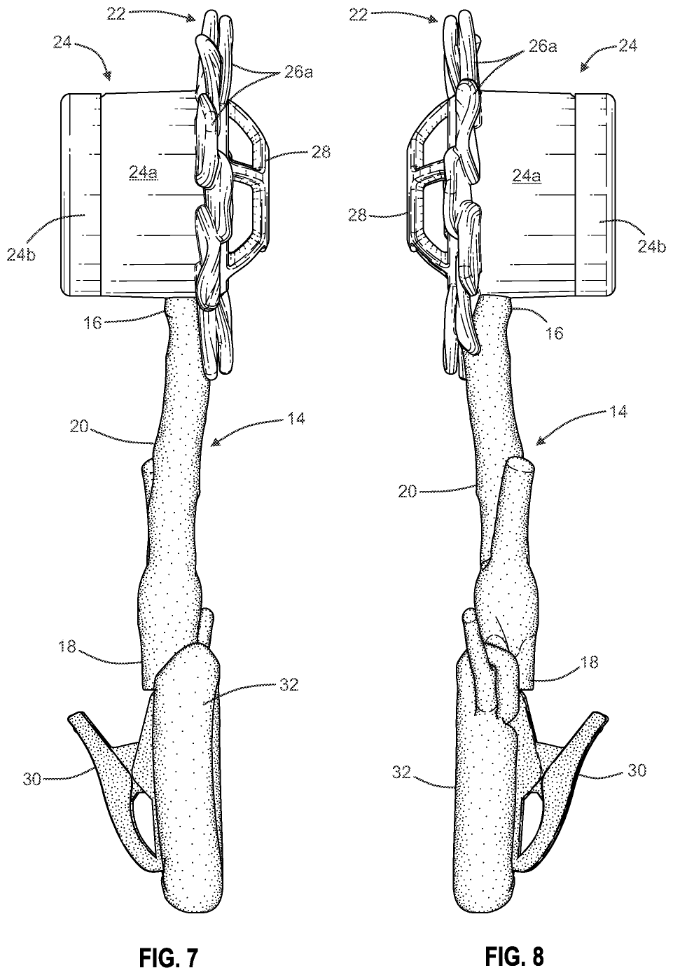

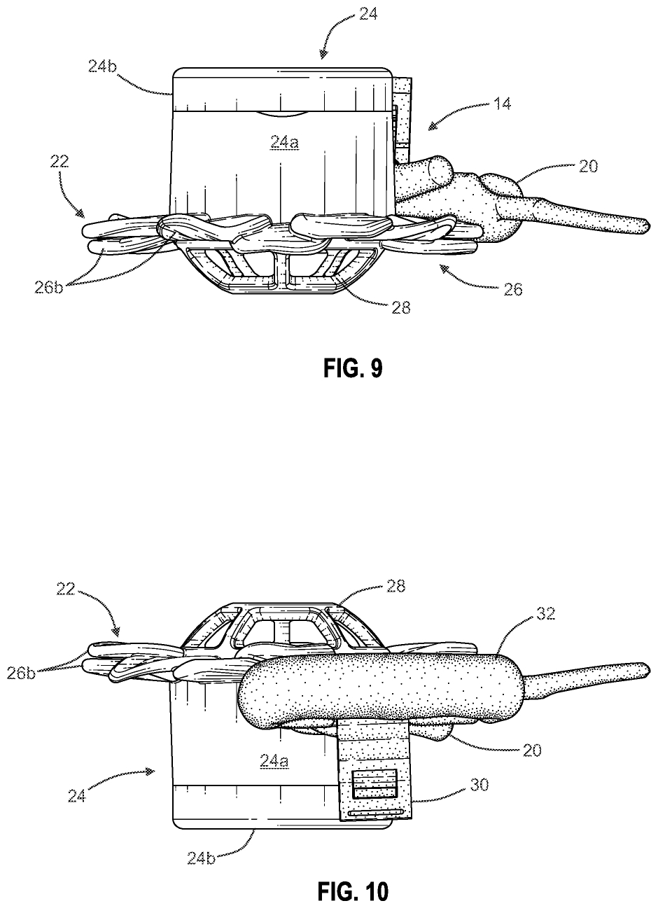

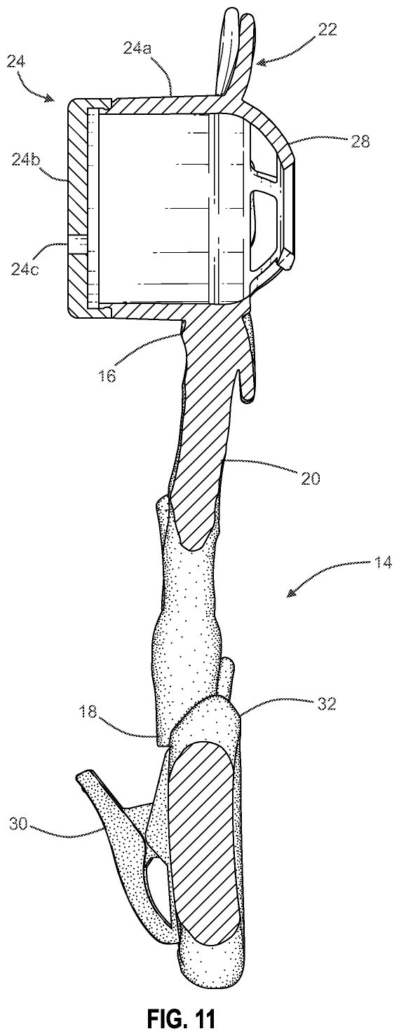

Referring to the drawings and particularly to FIGS. 1 and 2, one form of the present invention can be seen to comprise a hummingbird nesting platform 14 for use by hummingbirds in constructing a nest. Platform 14 includes a first end portion 16, a second end portion 18 and an intermediate portion 20. Intermediate portion 20 is decorated in a manner to simulate the appearance of a tree branch. Connected to first end portion 16 is a decorative nest building material dispensing assembly 22 having a nest building material supply assembly 24, a central design element 26 having a periphery 26a provided with a plurality of circumferentially spaced apart leaf shaped members 26b and centrally located refillable material dispensing cage 28 for dispensing nest building material. Supply assembly 24 includes a nest building material receiving body portion 24a (FIG. 4) and a removable cap portion 24b (FIG. 4). As illustrated in FIGS. 3 and 4 of the drawings, cap portion 24b is provided with a plurality of circumferentially spaced drainage and aeration apertures 24c.

Connected to second end portion 18 of the platform is a readily commercially available finger operated spring-loaded connecter clip means 30 that can be used to connect the nesting platform to an exterior structure such as branches of trees or shrubs.

Also connected to platform 14 proximate second end portion 18, is a nest building material holding structure 32 that comprises a walled nest holding chamber 34 for holding nesting material collected by the hummingbird from the nest building material supply cup 24 via the refillable dispensing cage 28.

In using the nest building platform of the invention, the cap portion 24b of the nest building material supply cup 24 is removed and the cup is filled with nesting fiber such as cotton fibers. By pushing inwardly on the nesting material, a portion of the material can be urged into the dispensing cage 28 and causing a multiplicity of cotton fibers to extend from the cage-like structure 28 so as to permit the hummingbird to easily remove selected fibers for use in constructing the nest. This done, using the finger operated spring-loaded clip means 30, the nesting platform can easily be connected to a selected branch of a tree or bush preferably at a height of above 6 feet. The platform should be located at least 30 feet apart from other nesting platforms and as far away as possible from the traffic of other birds nesting in the area.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A hummingbird nesting platform for use by hummingbirds in constructing a nest, said platform including:
(a) a first end portion.
(b) a second end portion.
(c) a decorative branch-like intermediate portion; and
(d) a decorative nest building material dispensing assembly connected to said first end portion.

2. The hummingbird nesting platform as defined in claim 1 further including connecting means connected to said second end portion for connecting said hummingbird nesting platform to an exterior structure.

3. The hummingbird nesting platform as defined in claim 1 further including a nest building material holding structure connected to said second end portion for holding nesting material collected by the hummingbird.

4. The hummingbird nesting platform as defined in claim 1 in which said decorative nest building material dispensing assembly includes a nest building material supply assembly for holding nesting material.

5. The hummingbird nesting platform as defined in claim 1 in which said decorative nest building material dispensing assembly includes a refillable material dispensing cage for dispensing nest building material.

6. The hummingbird nesting platform as defined in claim 1 in which the intermediate portion of the nesting platform is decorated in a manner to simulate the appearance of a tree branch.

7. A hummingbird nesting platform for use by hummingbirds in constructing a nest, said platform including;
(a) a first end portion;
(b) a second end portion;
(c) an intermediate portion;
(d) a decorative nest building material dispensing assembly connected to said first end portion, said assembly comprising a peripheral portion, a nest building material supply assembly, and a central refillable cage-like portion; and
(e) a nest building material holding structure connected to said second end portion for holding nesting material collected by the hummingbird, said structure comprising a walled chamber.

8. The hummingbird nesting platform as defined in claim 7 in which said peripheral portion of said decorative nest building material dispensing assembly comprises a plurality of leaf shaped members.

9. The hummingbird nesting platform as defined in claim 7 in which said supply assembly of said decorative nest building material dispensing assembly includes a body portion and a removable cap portion.

10. The hummingbird nesting platform as defined in claim 7 further including connecting means connected to said platform proximate said second end portion for connecting said hummingbird nesting platform to an exterior structure.

11. The hummingbird nesting platform as defined in claim 10 in which said connecting means comprises a finger operated spring-loaded connecter clip.

12. A hummingbird nesting platform for use by hummingbirds in constructing a nest, said platform including;
(a) a first end portion;
(b) a second end portion;
(c) an intermediate portion;
(d) a decorative nest building material dispensing assembly connected to said first end portion;
(e) a nest building material holding structure connected to said second end portion for holding nesting material collected by the hummingbird, said structure comprising a walled chamber, and
(f) connecting means connected to said platform proximate said second end portion for connecting said hummingbird nesting platform to an exterior structure.

13. The hummingbird nesting platform as defined in claim 12 in which said nest building material dispensing assembly includes a peripheral portion having a plurality of circumferentially spaced apart leaf shaped members.

14. The hummingbird nesting platform as defined in claim 12 in which the intermediate portion of the nesting platform is decorated in a manner to simulate the appearance of a tree branch.

15. The hummingbird nesting platform as defined in claim 12 in which said decorative nest building material dispensing assembly includes a centrally located material dispensing cage for dispensing nest building material.

16. The hummingbird nesting platform as defined in claim 15 in which said nest building material dispensing assembly includes a nest building material supply assembly.

17. The hummingbird nesting platform as defined in claim 16 in which said nest building material supply assembly includes a body portion.

18. The hummingbird nesting platform as defined in claim 16 in which said nest building material supply assembly includes a removable cap portion.

19. The hummingbird nesting platform as defined in claim 18 in which said removable cap portion of said nest building material dispensing assembly includes a plurality of circumferentially spaced drainage and aeration apertures.
